(19) United States
(12) Patent Application Publication
(10) Pub. No.: US 2008/0028191 A1
(43) Pub. Date: Jan. 31, 2008

(54) INSTRUCTION SET AND INFORMATION PROCESSING APPARATUS

(75) Inventor: Norio UTSUMI, OSAKA (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/777,763

(22) Filed: Jul. 13, 2007

(30) Foreign Application Priority Data
Jul. 25, 2006 (JP) 2006-201921

(51) Int. Cl. G06F 9/30

(52) U.S. Cl. 712/211

(57) ABSTRACT

An instruction set and an information processing apparatus are provided that improve parallelity of a program by using comparatively simple means. A method is provided in which in addition to a mnemonic assigned to an operation code of an instruction under present execution of a program, at least one or more mnemonics are assigned depending on an operation code or codes of at least one or more of instructions preceding and subsequent to the operation code of the instruction under present execution. This increases the number of instructions that can be defined by using the same instruction code width, and hence compresses the object size of a program. Accordingly, an excellent instruction set is realized that can improve the parallelity of a program by using comparatively simple means.

### BACKGROUND OF THE INVENTION

1. Field of the Invention

The present invention relates to an instruction set capable of reducing the code size and an information processing apparatus employing this instruction set.

2. Prior Art

In the prior art, methods such as VLIW and superscalar are known that improve the parallelity of instruction execution. In the VLIW, when the performance of a compiler is improved, the performance of instruction execution is improved. Nevertheless, the length of one instruction increases in comparison with that of a prior art processor. This causes a problem of code size increase. Further, since a plurality of instructions that do not depend on each other are executed collectively and simultaneously as one instruction, this approach is suitable for improving the parallelity of a program in a data processing system, but is not very effective for improving the parallelity of a program in a control system (see, for example, Non-Patent Document 1). On the other hand, in the superscalar, the hardware needs to be provided with a scheduler. Further, the hardware needs to resolve the dependency inherent in the software. Furthermore, hardware for speculative execution, branch prediction, and the like needs to be provided. On the basis of these, instruction execution can be controlled (see, for example, Iwanami Lectures, Microelectronics VLSI Computer I).

Nevertheless, in the prior art configurations described above, in the improving of the parallelity of a program, the VLIW has a problem of increase in the object size of a program. Further, the superscalar has a problem of complexity in the hardware.

### SUMMARY OF THE INVENTION

The present invention aims at resolving the above-mentioned problems in the prior art. An object of the present invention is to provide an instruction set and an information processing apparatus that improve parallelity of a program by using comparatively simple means.

In order to achieve the above-mentioned object, an instruction set according to a first invention comprises a method in which in addition to a mnemonic assigned to an operation code of an instruction under present execution of a program, at least one or more mnemonics are assigned depending on an operation code or codes of at least one or more of instructions preceding and subsequent to the operation code of the instruction under present execution.

This configuration increases the number of instructions that can be defined by using the same instruction code width, and hence compresses the object size of a program. Accordingly, an excellent instruction set is realized that can improve the parallelity of a program by using comparatively simple means.

An instruction set according to a second invention comprises, in the first invention, means for setting up validation or invalidation of the at least one or more mnemonics assigned to the operation code of the instruction under present execution.

According to this configuration, unnecessary parallel execution is avoided that could be generated by a situation that the mnemonic is determined depending on the operation codes of the preceding one instruction and the subsequent one instruction, so that correct program execution is achieved.

An instruction set according to third and fourth inventions comprises, in the first or the second inventions, at least two or more kinds of assignment methods for a mnemonic assigned to the operation code of the instruction under present execution; and means capable of selecting the assignment methods.

According to this configuration, an optimal code size is realized in accordance with the program.

An instruction set according to fifth through eighth inventions comprises, in any one of the first through the fourth inventions, means that, when two or more kinds of branch conditions are present in a program execution sequence, assigns all possible mnemonics to the operation codes corresponding to the branch conditions.

This configuration improves parallel execution performance in branching.

An information processing apparatus according to ninth through twelfth inventions comprises: instruction storing means for storing instructions of the instruction set according to any one of the first, the second, third, and the fifth inventions; instruction decoding means that is connected to the instruction storing means via an instruction bus so as to decode the instructions of the instruction set and assigns one operation code to a plurality of mnemonics on the basis of preceding and subsequent instructions; operation executing means that is connected to the instruction decoding means via a decoding bus and executes an operation on the basis of a result of decoding performed by the instruction decoding means; data storing means that is connected to the operation executing means via an execution result bus and stores an execution result of the operation executing means; and means that connects the instruction decoding means, the operation executing means, and the data storing means with each other via a data bus and sequentially executes the instructions of the instruction set stored in the instruction storing means.

According to this configuration, one operation code is assigned to a plurality of mnemonics on the basis of preceding and subsequent instructions. This realizes an information processing apparatus in which the program size is reduced, the processing speed is improved, and the number of kinds of instruction codes is reduced.

An information processing apparatus according to thirteenth through sixteenth inventions comprises, in any one of the ninth through the twelfth inventions, operand decoding means that is connected to the instruction storing means via an operand bus so as to decode an operand part of the instruction of the instruction set and assigns one operation code to a plurality of operands on the basis of information for assigning the operation code to the plurality of mnemonics.

According to this configuration, one operation code is assigned to a plurality of operands on the basis of preceding and subsequent instructions. Thus, in addition to reduction in the operation code size, the operand is multiplexed. Thus, usage capacity of the instruction memory is reduced.

### BRIEF DESCRIPTION OF THE DRAWINGS

FIG. 1 is an explanation diagram of an instruction set according to a first embodiment of the present invention.

FIG. 2 is an explanation diagram of an example of program execution according to a first embodiment of the present invention.

FIG. 3 is an explanation diagram of an example of program execution according to a second embodiment of the present invention.

FIG. 4 is an explanation diagram of a first assignment method for an instruction set according to a third embodiment of the present invention.

FIG. 5 is an explanation diagram of a second assignment method for an instruction set according to a third embodiment of the present invention.

FIG. 6 is an explanation diagram of an example of program execution according to a third embodiment of the present invention.

FIG. 7 is an explanation diagram of an instruction set according to a fourth embodiment of the present invention.

FIG. 8 is an explanation diagram of an example of program execution according to a fourth embodiment of the present invention.

FIG. 9 is a block diagram of an information processing apparatus according to a fifth embodiment of the present invention.

FIG. 10 is a block diagram of an information processing apparatus according to a sixth embodiment of the present invention.

### DESCRIPTION OF THE PREFERRED EMBODIMENTS

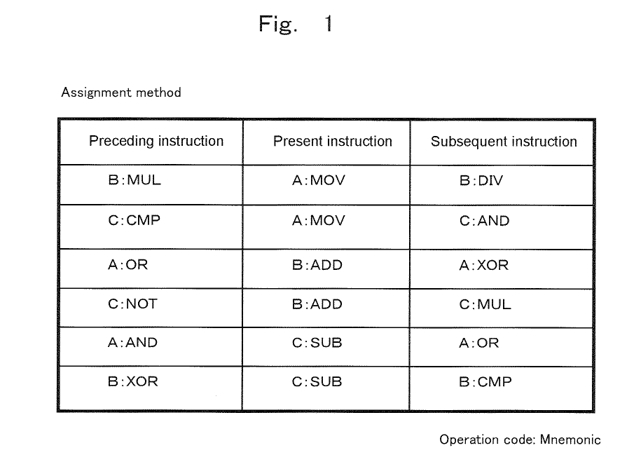

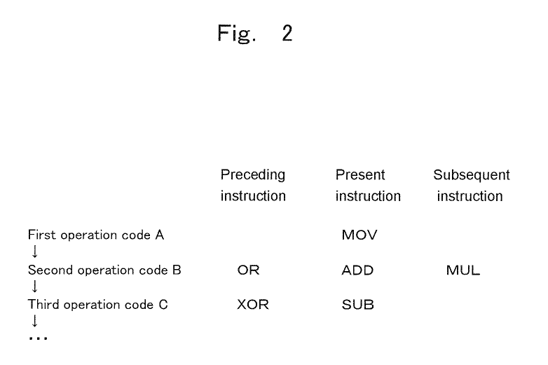

A first embodiment of the present invention is described below with reference to FIGS. 1 and 2.

FIG. 1 is a diagram showing a method of assigning a mnemonic to an operation code in an instruction set according to the present embodiment.

This instruction set comprises a method in which in addition to a mnemonic assigned to an operation code of an instruction under present execution of a program, at least one or more mnemonics are assigned depending on an operation code or codes of at least one or more of instructions preceding and subsequent to the operation code of the instruction under present execution.

For simplicity of description, the operation code of an instruction under present execution is assumed to depend on the operation codes of the preceding one instruction and the subsequent one instruction. A, B, and C indicate operation codes of instructions. When the operation codes of an instruction under present execution are A, B, and C, assigned mnemonic are assumed to be MOV, ADD, and SUB, respectively.

In a case that the operation code of the instruction under present execution is A and that the preceding instruction is B, in addition to the mnemonic MOV which is intrinsic to A, a mnemonic MUL is assigned to the operation code A of the instruction under present execution.

In a case that the operation code of the instruction under present execution is A and that the subsequent instruction is B, in addition to the mnemonic MOV which is intrinsic to A, a mnemonic DIV is assigned to the operation code A of the instruction under present execution.

In a case that the operation code of the instruction under present execution is A and that the preceding instruction is C, in addition to the mnemonic MOV which is intrinsic to A, a mnemonic CMP is assigned to the operation code A of the instruction under present execution.

In a case that the operation code of the instruction under present execution is A and that the subsequent instruction is C, in addition to the mnemonic MOV which is intrinsic to A, a mnemonic AND is assigned to the operation code A of the instruction under present execution.

Next, in a case that the operation code of the instruction under present execution is B and that the preceding instruction is A, in addition to the mnemonic ADD which is intrinsic to B, a mnemonic OR is assigned to the operation code B of the instruction under present execution.

In a case that the operation code of the instruction under present execution is B and that the subsequent instruction is A, in addition to the mnemonic ADD which is intrinsic to B, a mnemonic XOR is assigned to the operation code B of the instruction under present execution.

In a case that the operation code of the instruction under present execution is B and that the preceding instruction is C, in addition to the mnemonic ADD which is intrinsic to B, a mnemonic NOT is assigned to the operation code B of the instruction under present execution.

In a case that the operation code of the instruction under present execution is B and that the subsequent instruction is C, in addition to the mnemonic ADD which is intrinsic to B, a mnemonic MUL is assigned to the operation code B of the instruction under present execution.

Next, in a case that the operation code of the instruction under present execution is C and that the preceding instruction is A, in addition to the mnemonic SUB which is intrinsic to C, a mnemonic AND is assigned to the operation code C of the instruction under present execution.

In a case that the operation code of the instruction under present execution is C and that the subsequent instruction is A, in addition to the mnemonic SUB which is intrinsic to C, a mnemonic OR is assigned to the operation code C of the instruction under present execution.

In a case that the operation code of the instruction under present execution is C and that the preceding instruction is B, in addition to the mnemonic SUB which is intrinsic to C, a mnemonic XOR is assigned to the operation code C of the instruction under present execution.

In a case that the operation code of the instruction under present execution is C and that the subsequent instruction is B, in addition to the mnemonic SUB which is intrinsic to C, a mnemonic CMP is assigned to the operation code C of the instruction under present execution.

Operation is described below for the instruction set having the above-mentioned configuration according to the present embodiment.

FIG. 2 is a diagram showing: a result that a mnemonic is assigned to an operation code in the instruction set of the present embodiment; and an example of program execution.

For simplicity of description, explanation is given below for a program in which operation codes A, B, and C are arranged in this order.

The instruction executed first is the first operation code A. When the operation code A is an instruction under present execution, MOV is assigned as a mnemonic.

The instruction executed second is the second operation code B. When the operation code B is an instruction under present execution, ADD is assigned as a mnemonic. In a case that the preceding instruction is A, OR is assigned in addition to ADD. In a case that the subsequent instruction is C, MUL is assigned in addition to ADD and OR.

The instruction executed third is the third operation code C. When the operation code C is an instruction under present execution, SUB is assigned as a mnemonic. In a case that the preceding instruction is B, XOR is assigned in addition to SUB.

As described above, according to the present embodiment, an instruction set is provided in which in addition to a mnemonic assigned to the operation code of the instruction under present execution, at least one or more mnemonics are assigned depending on the operation code or codes of at least one or more preceding and subsequent instructions. This increases the number of instructions that can be defined by using the same instruction code width, and hence compresses the object size of a program.

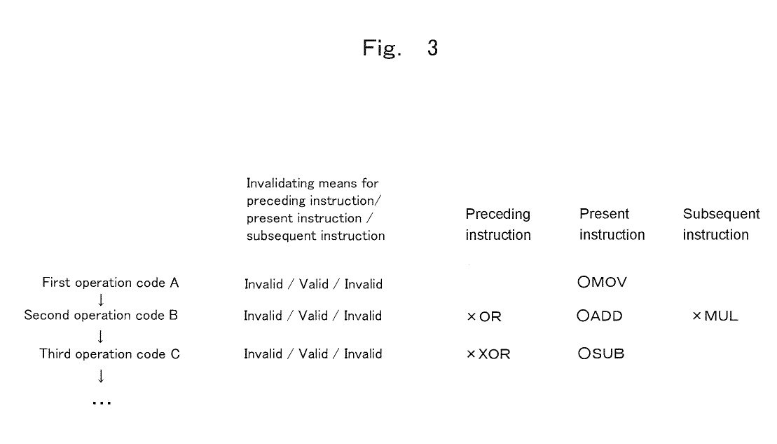

A second embodiment of the present invention is described below with reference to FIG. 3.

FIG. 3 is a diagram showing: a result that a mnemonic is assigned to an operation code in an instruction set according to the second embodiment of the present embodiment; and an example of program execution.

This instruction set comprises means for setting up validation or invalidation of the at least one or more mnemonics assigned to the operation code of the instruction under present execution.

For simplicity of description, the operation code of an instruction under present execution is assumed to depend on the operation codes of the preceding one instruction and the subsequent one instruction.

A three-bit field is provided in the operation code. Then, it is assumed that in the first, the second, and the third bits, validation or invalidation can be set up respectively for the mnemonic of the instruction under present execution, the mnemonic assigned depending on the preceding instruction, and the mnemonic assigned depending on the subsequent instruction.

In a program in which operation codes A, B, and C are arranged in this order, MOV which is the intrinsic mnemonic to the operation code A is assumed to be assigned as a mnemonic to the first operation code A.

As mnemonics to the second operation code B, ADD which is the intrinsic mnemonic to the operation code B, OR which is a mnemonic to be assigned depending on the preceding instruction, and MUL which is a mnemonic to be assigned depending on the subsequent instruction are assumed to be assigned.

To the third operation code C, SUB which is the intrinsic mnemonic to the operation code C and XOR which is a mnemonic to be assigned depending on the preceding instruction are assumed to be assigned.

Operation is described below for the instruction set having the above-mentioned configuration according to the second embodiment.

For simplicity of description, explanation is given below for a program in which operation codes A, B, and C are arranged in this order.

In a program in which operation codes A, B, and C are arranged in this order, MOV which is the intrinsic mnemonic to the operation code A is assigned as a mnemonic to the first operation code A. Then, the first, the second, and the third bits of the mnemonic validity-invalidity setting field are validity, invalidity, and invalidity, respectively. Thus, MOV is solely executed that is the mnemonic of the instruction under present execution.

As a mnemonic to the second operation code B, ADD which is the intrinsic mnemonic to the operation code B, OR which is a mnemonic to be assigned depending on the preceding instruction, and MUL which is a mnemonic to be assigned depending on the subsequent instruction are assigned. Then, the first, the second, and the third bits of the mnemonic validity-invalidity setting field are validity, invalidity, and invalidity, respectively. Thus, ADD is solely executed that is the mnemonic of the instruction under present execution.

To the third operation code C, SUB which is the intrinsic mnemonic to the operation code C and XOR which is a mnemonic to be assigned depending on the preceding instruction are assigned. Then, the first, the second, and the third bits of the mnemonic validity-invalidity setting field are validity, invalidity, and invalidity, respectively. Thus, SUB is solely executed that is the mnemonic of the instruction under present execution.

As described above, according to the second embodiment of the present invention, means is provided that sets up validation or invalidation of the at least one or more mnemonics assigned to the operation code of the instruction under present execution. This avoids unnecessary parallel execution that could be generated by a situation that the mnemonic is determined depending on the operation codes of the preceding one instruction and the subsequent one instruction, so that correct program execution is achieved.

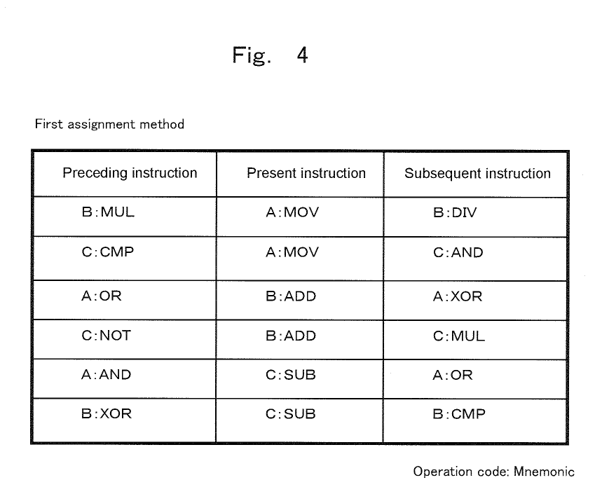

A third embodiment of the present invention is described below with reference to FIGS. 4 through 6.

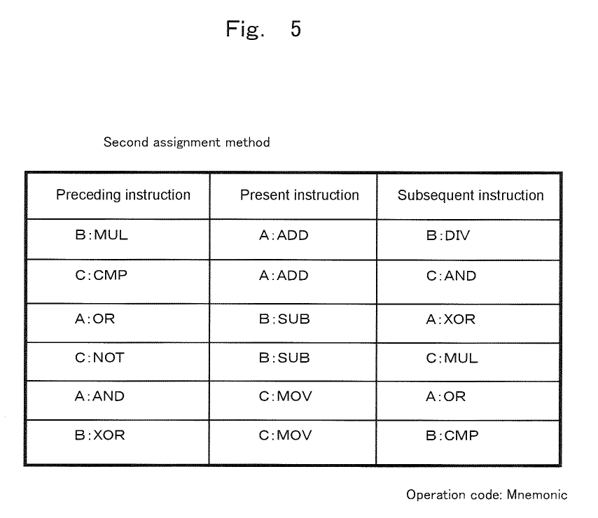

FIGS. 4 and 5 are diagrams showing a method of assigning a mnemonic to an operation code in an instruction set according to the third embodiment of the present embodiment.

This instruction set comprises: at least two or more kinds of assignment methods for a mnemonic assigned to the operation code of the instruction under present execution; and means capable of selecting the assignment methods.

For simplicity of description, the operation code of an instruction under present execution is assumed to depend on the operation codes of the preceding one instruction and the subsequent one instruction.

In FIG. 4, A, B, and C indicate operation codes of instructions. When the operation codes of an instruction under present execution are A, B, and C, assigned mnemonic are assumed to be MOV, ADD, and SUB, respectively.

In a case that the operation code of the instruction under present execution is A and that the preceding instruction is B, in addition to the mnemonic MOV which is intrinsic to A, a mnemonic MUL is assigned to the operation code A of the instruction under present execution.

In a case that the operation code of the instruction under present execution is A and that the subsequent instruction is B, in addition to the mnemonic MOV which is intrinsic to A, a mnemonic DIV is assigned to the operation code A of the instruction under present execution.

In a case that the operation code of the instruction under present execution is A and that the preceding instruction is C, in addition to the mnemonic MOV which is intrinsic to A, a mnemonic CMP is assigned to the operation code A of the instruction under present execution.

In a case that the operation code of the instruction under present execution is A and that the subsequent instruction is C, in addition to the mnemonic MOV which is intrinsic to A, a mnemonic AND is assigned to the operation code A of the instruction under present execution.

Next, in a case that the operation code of the instruction under present execution is B and that the preceding instruction is A, in addition to the mnemonic ADD which is intrinsic to B, a mnemonic OR is assigned to the operation code B of the instruction under present execution.

In a case that the operation code of the instruction under present execution is B and that the subsequent instruction is A, in addition to the mnemonic ADD which is intrinsic to B, a mnemonic XOR is assigned to the operation code B of the instruction under present execution.

In a case that the operation code of the instruction under present execution is B and that the preceding instruction is C, in addition to the mnemonic ADD which is intrinsic to B, a mnemonic NOT is assigned to the operation code B of the instruction under present execution.

In a case that the operation code of the instruction under present execution is B and that the subsequent instruction is C, in addition to the mnemonic ADD which is intrinsic to B, a mnemonic MUL is assigned to the operation code B of the instruction under present execution.

Next, in a case that the operation code of the instruction under present execution is C and that the preceding instruction is A, in addition to the mnemonic SUB which is intrinsic to C, a mnemonic AND is assigned to the operation code C of the instruction under present execution.

In a case that the operation code of the instruction under present execution is C and that the subsequent instruction is A, in addition to the mnemonic SUB which is intrinsic to C, a mnemonic OR is assigned to the operation code C of the instruction under present execution.

In a case that the operation code of the instruction under present execution is C and that the preceding instruction is B, in addition to the mnemonic SUB which is intrinsic to C, a mnemonic XOR is assigned to the operation code C of the instruction under present execution.

In a case that the operation code of the instruction under present execution is C and that the subsequent instruction is B, in addition to the mnemonic SUB which is intrinsic to C, a mnemonic CMP is assigned to the operation code C of the instruction under present execution.

In FIG. 5, A, B, and C indicate operation codes of instructions. When the operation codes of an instruction under present execution are A, B, and C, assigned mnemonic are assumed to be ADD, SUB, and MOV, respectively.

In a case that the operation code of the instruction under present execution is A and that the preceding instruction is B, in addition to the mnemonic ADD which is intrinsic to A, a mnemonic MUL is assigned to the operation code A of the instruction under present execution.

In a case that the operation code of the instruction under present execution is A and that the subsequent instruction is B, in addition to the mnemonic ADD which is intrinsic to A, a mnemonic DIV is assigned to the operation code A of the instruction under present execution.

In a case that the operation code of the instruction under present execution is A and that the preceding instruction is C, in addition to the mnemonic ADD which is intrinsic to A, a mnemonic CMP is assigned to the operation code A of the instruction under present execution.

In a case that the operation code of the instruction under present execution is A and that the subsequent instruction is C, in addition to the mnemonic ADD which is intrinsic to A, a mnemonic AND is assigned to the operation code A of the instruction under present execution.

Next, in a case that the operation code of the instruction under present execution is B and that the preceding instruction is A, in addition to the mnemonic SUB which is intrinsic to B, a mnemonic OR is assigned to the operation code B of the instruction under present execution.

In a case that the operation code of the instruction under present execution is B and that the subsequent instruction is A, in addition to the mnemonic SUB which is intrinsic to B, a mnemonic XOR is assigned to the operation code B of the instruction under present execution.

In a case that the operation code of the instruction under present execution is B and that the preceding instruction is C, in addition to the mnemonic SUB which is intrinsic to B, a mnemonic NOT is assigned to the operation code B of the instruction under present execution.

In a case that the operation code of the instruction under present execution is B and that the subsequent instruction is C, in addition to the mnemonic SUB which is intrinsic to B, a mnemonic MUL is assigned to the operation code B of the instruction under present execution.

Next, in a case that the operation code of the instruction under present execution is C and that the preceding instruction is A, in addition to the mnemonic MOV which is intrinsic to C, a mnemonic AND is assigned to the operation code C of the instruction under present execution.

In a case that the operation code of the instruction under present execution is C and that the subsequent instruction is A, in addition to the mnemonic MOV which is intrinsic to C, a mnemonic OR is assigned to the operation code C of the instruction under present execution.

In a case that the operation code of the instruction under present execution is C and that the preceding instruction is B, in addition to the mnemonic MOV which is intrinsic to C, a mnemonic XOR is assigned to the operation code C of the instruction under present execution.

In a case that the operation code of the instruction under present execution is C and that the subsequent instruction is B, in addition to the mnemonic MOV which is intrinsic to C, a mnemonic CMP is assigned to the operation code C of the instruction under present execution.

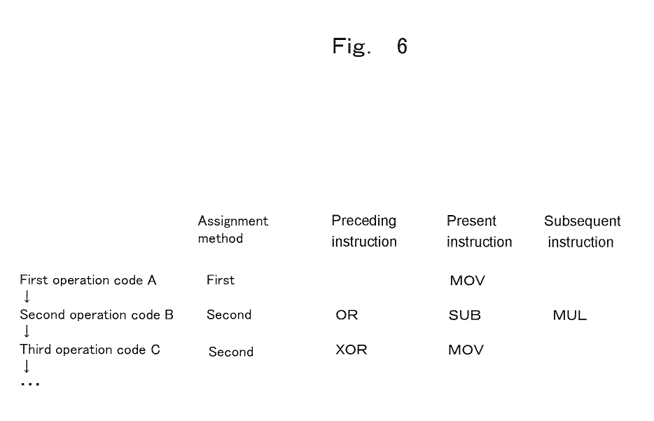

FIG. 6 is a diagram showing: a result that a mnemonic is assigned to an operation code in the instruction set according to the third embodiment of the present embodiment; and an example of program execution.

As shown in FIG. 6, a one-bit field is provided in the operation code. Then, it is assumed that the first bit can be utilized for the setting whether a first assignment method or a second assignment method is to be used for the determination of the mnemonic of an instruction under present execution.

Operation is described below for the instruction set having the above-mentioned configuration according to the present embodiment.

For simplicity of description, explanation is given below for a program in which operation codes A, B, and C are arranged in this order.

The instruction executed first is the first operation code A, while the mnemonic assignment method to be used is the first assignment method. When the operation code A is an instruction under present execution, MOV is assigned as a mnemonic.

The instruction executed second is the second operation code B, while the mnemonic assignment method to be used is the second assignment method. When the operation code B is an instruction under present execution, SUB is assigned as a mnemonic. In a case that the preceding instruction is A, OR is assigned in addition to SUB. In a case that the subsequent instruction is C, MUL is assigned in addition to SUB and OR.

The instruction executed third is the third operation code C, while the mnemonic assignment method to be used is the second assignment method. When the operation code C is an instruction under present execution, MOV is assigned as a mnemonic. In a case that the preceding instruction is B, XOR is assigned in addition to MOV.

As described above, according to the third embodiment of the present invention, at least two or more kinds of methods of assigning a mnemonic to the operation code of the instruction under present execution depending on the operation code or codes of at least one or more of preceding and subsequent instructions are provided. Thus, an optimal code size is realized in accordance with the program. That is, when a plurality of assignment methods are provided, a high flexibility is obtained in the generation of the instruction sequence based on the instruction under present execution and the preceding and the subsequent instructions in comparison with a case that one assignment method is solely provided. This realizes a small code size.

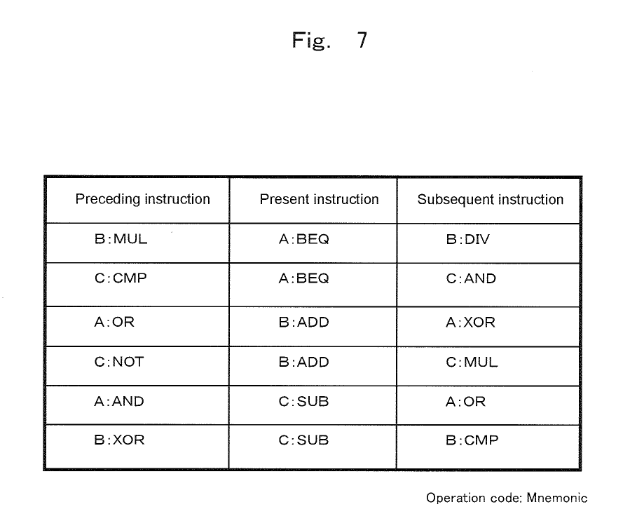

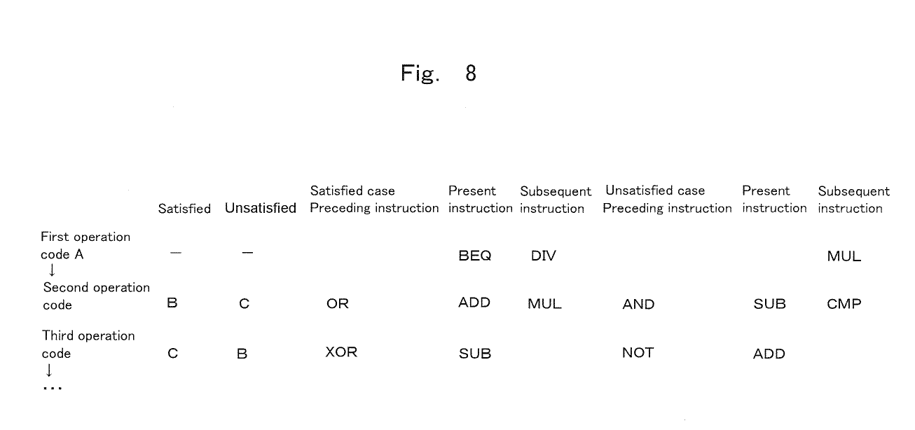

A fourth embodiment of the present invention is described below with reference to FIGS. 7 and 8.

FIG. 7 is a diagram showing a method of assigning a mnemonic to an operation code in an instruction set according to the fourth embodiment of the present embodiment.

This instruction set comprises means that, when two or more kinds of branch conditions are present in a program execution sequence, assigns all possible mnemonics to the operation codes corresponding to the branch conditions.

For simplicity of description, the operation code of an instruction under present execution is assumed to depend on the operation codes of the preceding one instruction and the subsequent one instruction.

In FIG. 7, A, B, and C indicate operation codes of instructions. When the operation codes of an instruction under present execution are A, B, and C, assigned mnemonic are assumed to be BEQ, ADD, and SUB, respectively.

In a case that the operation code of the instruction under present execution is A and that the preceding instruction is B, in addition to the mnemonic BEQ which is intrinsic to A, a mnemonic MUL is assigned to the operation code A of the instruction under present execution.

In a case that the operation code of the instruction under present execution is A and that the subsequent instruction is B, in addition to the mnemonic BEQ which is intrinsic to A, a mnemonic DIV is assigned to the operation code A of the instruction under present execution.

In a case that the operation code of the instruction under present execution is A and that the preceding instruction is C, in addition to the mnemonic BEQ which is intrinsic to A, a mnemonic CMP is assigned to the operation code A of the instruction under present execution.

In a case that the operation code of the instruction under present execution is A and that the subsequent instruction is C, in addition to the mnemonic BEQ which is intrinsic to A, a mnemonic AND is assigned to the operation code A of the instruction under present execution.

Next, in a case that the operation code of the instruction under present execution is B and that the preceding instruction is A, in addition to the mnemonic ADD which is intrinsic to B, a mnemonic OR is assigned to the operation code B of the instruction under present execution.

In a case that the operation code of the instruction under present execution is B and that the subsequent instruction is A, in addition to the mnemonic ADD which is intrinsic to B, a mnemonic XOR is assigned to the operation code B of the instruction under present execution.

In a case that the operation code of the instruction under present execution is B and that the preceding instruction is C, in addition to the mnemonic ADD which is intrinsic to B, a mnemonic NOT is assigned to the operation code B of the instruction under present execution.

In a case that the operation code of the instruction under present execution is B and that the subsequent instruction is C, in addition to the mnemonic ADD which is intrinsic to B, a mnemonic MUL is assigned to the operation code B of the instruction under present execution.

Next, in a case that the operation code of the instruction under present execution is C and that the preceding instruction is A, in addition to the mnemonic SUB which is intrinsic to C, a mnemonic AND is assigned to the operation code C of the instruction under present execution.

In a case that the operation code of the instruction under present execution is C and that the subsequent instruction is A, in addition to the mnemonic SUB which is intrinsic to C, a mnemonic OR is assigned to the operation code C of the instruction under present execution.

In a case that the operation code of the instruction under present execution is C and that the preceding instruction is B, in addition to the mnemonic SUB which is intrinsic to C, a mnemonic XOR is assigned to the operation code C of the instruction under present execution.

In a case that the operation code of the instruction under present execution is C and that the subsequent instruction is B, in addition to the mnemonic SUB which is intrinsic to C, a mnemonic CMP is assigned to the operation code C of the instruction under present execution.

FIG. 8 is a diagram showing: a result that a mnemonic is assigned to an operation code in the instruction set according to the fourth embodiment of the present embodiment; and an example of program execution.

As shown in FIG. 8, it is assumed that the first operation code is A and that the assigned mnemonic is BEQ. Since BEQ is a branch instruction, the operation codes of the subsequent instruction to be executed when the branch condition is satisfied are assumed to be B and C. The operation codes of the subsequent instruction to be executed when the branch condition is not satisfied are assumed to be C and B.

The operation code B of the subsequent instruction to be executed when the branch condition is satisfied and the operation code C of the subsequent instruction to be executed when the branch condition is not satisfied are assumed to be assigned to the second operation code.

The operation code C of the subsequent instruction to be executed when the branch condition is satisfied and the operation code B of the subsequent instruction to be executed when the branch condition is not satisfied are assumed to be assigned to the third operation code.

A case that the branch condition of the first operation code is satisfied is described below.

When the first, the second, and the third operation codes are A, B, and C, respectively, the assigned mnemonics are BEQ, ADD, and SUB, respectively.

In a case that the operation code of the instruction under present execution is A and that the subsequent instruction is B, in addition to the mnemonic BEQ which is intrinsic to A, a mnemonic DIV is assigned to the operation code A of the instruction under present execution.

In a case that the operation code of the instruction under present execution is B and that the preceding instruction is A, in addition to the mnemonic ADD which is intrinsic to B, a mnemonic OR is assigned to the operation code B of the instruction under present execution.

In a case that the operation code of the instruction under present execution is B and that the subsequent instruction is C, in addition to the mnemonic ADD which is intrinsic to B, a mnemonic MUL is assigned to the operation code B of the instruction under present execution.

In a case that the operation code of the instruction under present execution is C and that the preceding instruction is B, in addition to the mnemonic SUB which is intrinsic to C, a mnemonic XOR is assigned to the operation code C of the instruction under present execution.

Next, a case that the branch condition of the first operation code is unsatisfied is described below.

When the second and the third operation codes are A, C, and B, respectively, the assigned mnemonics are SUB and ADD, respectively.

In a case that the operation code of the instruction under present execution is A and that the subsequent instruction is C, in addition to the mnemonic BEQ which is intrinsic to A, a mnemonic MUL is assigned to the operation code A of the instruction under present execution.

In a case that the operation code of the instruction under present execution is C and that the preceding instruction is A, in addition to the mnemonic SUB which is intrinsic to C, a mnemonic AND is assigned to the operation code C of the instruction under present execution.

In a case that the operation code of the instruction under present execution is C and that the subsequent instruction is A, in addition to the mnemonic SUB which is intrinsic to C, a mnemonic CMP is assigned to the operation code C of the instruction under present execution.

In a case that the operation code of the instruction under present execution is B and that the preceding instruction is C, in addition to the mnemonic ADD which is intrinsic to B, a mnemonic NOT is assigned to the operation code B of the instruction under present execution.

Operation is described below for the instruction set having the above-mentioned configuration according to the present embodiment.

The instruction executed first is the first operation code A. When the operation code A is an instruction under present execution, BEQ is assigned as a mnemonic.

The assignment of mnemonics to be used is assumed to be as follows. When the condition of BEQ is satisfied, the second and the third operation codes are assigned to B and C, respectively. When the condition of BEQ is unsatisfied, the second and the third operation codes are assigned to C and B, respectively. Since the operation codes subsequent to the operation code A are B and C, BEQ, DIV, and MUL are assigned as mnemonics.

The instruction executed second is the second operation code B or C. When the operation code B or C is an instruction under present execution, ADD or SUB is assigned as a mnemonic.

In the assignment of mnemonics to be used, when the condition of BEQ is satisfied, the first operation code is A while the third operation code is C or B, respectively. Thus, OR, ADD, MUL, AND, SUB, and CMP are assigned as mnemonics.

The instruction executed third is the third operation code C or B. When the operation code C or B is an instruction under present execution, SUB or ADD is assigned as a mnemonic.

In the assignment of mnemonics to be used, when the condition of BEQ is satisfied, the second operation code is B or C, respectively. Thus, XOR, SUB, NOT, and ADD are assigned as mnemonics.

As described above, according to the fourth embodiment of the present invention, an instruction set is provided in which when two or more kinds of execution possibilities in a program execution sequence, all possible mnemonics can be assigned to the operation code. This improves parallel execution performance in branching.

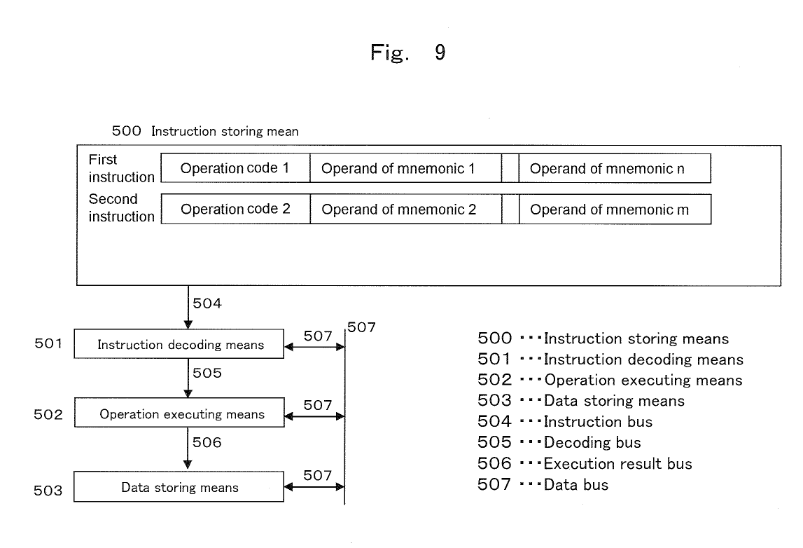

A fifth embodiment of the present invention is described below with reference to FIG. 9.

FIG. 9 shows an information processing apparatus that comprises means for sequentially executing instructions in the instruction set according to the fourth embodiment of the present invention.

In FIG. 9, numeral 500 indicates instruction storing means for storing an instruction of the instruction set according to any one of the first through the fourth embodiments. Numeral 501 indicates instruction decoding means for decoding an instruction of the instruction set. Numeral 502 indicates operation executing means for executing operation on the basis of the result of decoding performed by the instruction decoding means 501. Numeral 503 indicates data storing means for storing the execution result of the operation executing means 502. Numeral 504 indicates an instruction bus for connecting the instruction storing means 500 with the instruction decoding means 501. Numeral 505 indicates a decoding bus for connecting the instruction decoding means 501 with the operation executing means 502. Numeral 506 indicates an execution result bus for connecting the operation executing means 502 with the data storing means 503. Numeral 507 indicates a data bus for connecting the instruction decoding means 501, the operation executing means 502, and the data storing means 503 with each other.

Operation is describes below for the information processing apparatus having the above-mentioned configuration according to the fifth embodiment.

The instruction storing means 500 stores instructions of the instruction set. Each of the first instruction and the second instruction is constructed from: one operation code that can be assigned to a plurality of mnemonics on the basis of preceding and subsequent instructions; and operands corresponding to the plurality of mnemonics. These are stored in the instruction storing means 500. The first instruction is inputted from the instruction storing means 500 via the instruction bus 504 to the instruction decoding means 501. The instruction decoding means 501 assigns one operation code to a plurality of mnemonics on the basis of preceding and subsequent instructions. The plurality of mnemonics generated by the instruction decoding means 501 are inputted via the decoding bus 505 to the operation executing means 502. The operands corresponding to the plurality of mnemonics are transmitted via the data bus 507, and then processed by the operation executing means 502 and the data storing means 503 depending on the plurality of mnemonics. Then, the data is stored in accordance with the operands corresponding to the plurality of mnemonics. After the completion of processing of the first instruction, the second instruction is processed succeedingly.

As described above, the fifth embodiment of the present invention employs: instruction storing means; instruction decoding means that is connected to the instruction storing means via an instruction bus; operation executing means that is connected to the instruction decoding means via a decoding bus; data storing means that is connected to the operation executing means via an execution result bus; and means that connects the instruction decoding means, the operation executing means, and the data storing means with each other via a data bus and that stores an instruction set into the instruction storing means and sequentially executes the instructions. By virtue of this, one operation code is assigned to a plurality of mnemonics on the basis of preceding and subsequent instructions. This realizes an information processing apparatus in which the program size is reduced, the processing speed is improved, and the number of kinds of instruction codes is reduced.

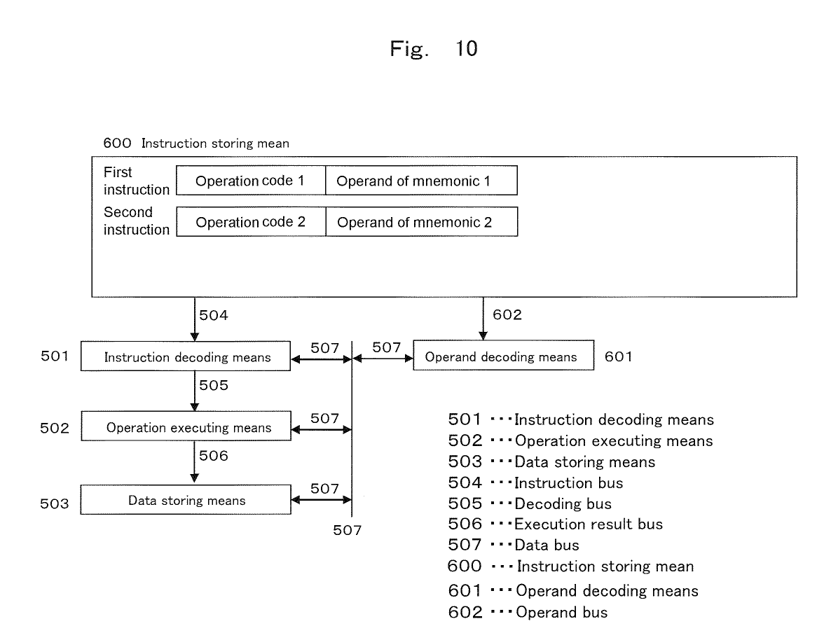

A sixth embodiment of the present invention is described below with reference to FIG. 10.

FIG. 10 shows an information processing apparatus comprising operand decoding means connected to an instruction storing means via an operand bus according to the sixth embodiment of the present invention.

In FIG. 10, numeral 600 indicates instruction storing means for storing instructions of the instruction set according to any one of the first through the fourth embodiments. Numeral 601 indicates operand decoding means for decoding the operand portion of the instruction stored in the instruction storing means 600. Numeral 602 indicates an operand bus for connecting the instruction storing means 600 with the operand decoding means 601.

Operation is describes below for the information processing apparatus having the above-mentioned configuration according to the sixth embodiment.

The instruction storing means 600 stores instructions of the instruction set. Each of the first instruction and the second instruction is constructed from: one operation code that can be assigned to a plurality of mnemonics on the basis of preceding and subsequent instructions; and one operand that represents the operands corresponding to the plurality of mnemonics. These are stored in the instruction storing means 600. The first instruction is inputted from the instruction storing means 600 via the instruction bus 504 to the instruction decoding means 501. The instruction decoding means 501 assigns one operation code to a plurality of mnemonics on the basis of preceding and subsequent instructions. The plurality of mnemonics generated by the instruction decoding means 501 are inputted via the decoding bus 505 to the operation executing means 502. At the same time, one operand that represents the operands corresponding to the plurality of mnemonics is inputted from the instruction storing means 600 via the operand bus 602 to the operand decoding means 601. In accordance with the information for assigning one operation code to a plurality of mnemonics on the basis of preceding and subsequent instructions in the instruction decoding means 501, the operand decoding means 601 assigns one operation code to a plurality of operands.

As described above, the sixth embodiment of the present invention employs operand decoding means connected to instruction storing means via an operand bus. By virtue of this, in addition to that one operation code is assigned to a plurality of mnemonics on the basis of preceding and subsequent instructions, one operation code is assigned to a plurality of operands on the basis of preceding and subsequent instructions. Accordingly, in addition to reduction in the operation code size, the operand is multiplexed. Thus, usage capacity of the instruction memory is reduced.

1. An instruction set comprising a method in which in addition to a mnemonic assigned to an operation code of an instruction under present execution of a program, at least one or more mnemonics are assigned depending on an operation code or codes of at least one or more of instructions preceding and subsequent to the operation code of said instruction under present execution.

2. An instruction set according to claim 1, comprising means for setting up validation or invalidation of the at least one or more mnemonics assigned to the operation code of the instruction under present execution.

3. An instruction set according to claim 1, comprising: at least two or more kinds of assignment methods for a mnemonic assigned to the operation code of the instruction under present execution; and means capable of selecting said assignment methods.

4. An instruction set according to claim 2, comprising: at least two or more kinds of assignment methods for a mnemonic assigned to the operation code of the instruction under present execution; and means capable of selecting said assignment methods.

5. An instruction set according to claim 1, comprising means that, when two or more kinds of branch conditions are present in a program execution sequence, assigns all possible mnemonics to the operation codes corresponding to said branch conditions.

6. An instruction set according to claim 2, comprising means that, when two or more kinds of branch conditions are present in a program execution sequence, assigns all possible mnemonics to the operation codes corresponding to said branch conditions.

7. An instruction set according to claim 3, comprising means that, when two or more kinds of branch conditions are present in a program execution sequence, assigns all possible mnemonics to the operation codes corresponding to said branch conditions.

8. An instruction set according to claim 4, comprising means that, when two or more kinds of branch conditions are present in a program execution sequence, assigns all possible mnemonics to the operation codes corresponding to said branch conditions.

9. An information processing apparatus comprising:
instruction storing means for storing instructions of the instruction set according to claim 1;
instruction decoding means that is connected to said instruction storing means via an instruction bus so as to decode the instructions of said instruction set and assigns one operation code to a plurality of mnemonics on the basis of preceding and subsequent instructions;
operation executing means that is connected to said instruction decoding means via a decoding bus and executes an operation on the basis of a result of decoding performed by said instruction decoding means;
data storing means that is connected to said operation executing means via an execution result bus and stores an execution result of said operation executing means; and
means that connects said instruction decoding means, said operation executing means, and said data storing means with each other via a data bus and sequentially executes the instructions of the instruction set stored in said instruction storing means.

10. An information processing apparatus comprising:
instruction storing means for storing instructions of the instruction set according to claim 2;
instruction decoding means that is connected to said instruction storing means via an instruction bus so as to decode the instructions of said instruction set and assigns one operation code to a plurality of mnemonics on the basis of preceding and subsequent instructions;
operation executing means that is connected to said instruction decoding means via a decoding bus and executes an operation on the basis of a result of decoding performed by said instruction decoding means;
data storing means that is connected to said operation executing means via an execution result bus and stores an execution result of said operation executing means; and
means that connects said instruction decoding means, said operation executing means, and said data storing means with each other via a data bus and sequentially executes the instructions of the instruction set stored in said instruction storing means.

11. An information processing apparatus comprising:
instruction storing means for storing instructions of the instruction set according to claim 3;
instruction decoding means that is connected to said instruction storing means via an instruction bus so as to decode the instructions of said instruction set and assigns one operation code to a plurality of mnemonics on the basis of preceding and subsequent instructions;
operation executing means that is connected to said instruction decoding means via a decoding bus and executes an operation on the basis of a result of decoding performed by said instruction decoding means;
data storing means that is connected to said operation executing means via an execution result bus and stores an execution result of said operation executing means; and
means that connects said instruction decoding means, said operation executing means, and said data storing means with each other via a data bus and sequentially executes the instructions of the instruction set stored in said instruction storing means.

12. An information processing apparatus comprising:
instruction storing means for storing instructions of the instruction set according to claim 5;
instruction decoding means that is connected to said instruction storing means via an instruction bus so as to decode the instructions of said instruction set and assigns one operation code to a plurality of mnemonics on the basis of preceding and subsequent instructions;
operation executing means that is connected to said instruction decoding means via a decoding bus and executes an operation on the basis of a result of decoding performed by said instruction decoding means;
data storing means that is connected to said operation executing means via an execution result bus and stores an execution result of said operation executing means; and
means that connects said instruction decoding means, said operation executing means, and said data storing means with each other via a data bus and sequentially executes the instructions of the instruction set stored in said instruction storing means.

13. An information processing apparatus according to claim 9, comprising operand decoding means that is connected to said instruction storing means via an operand bus so as to decode an operand part of the instruction of said instruction set and assigns one operation code to a plurality of operands on the basis of information for assigning the operation code to said plurality of mnemonics.

14. An information processing apparatus according to claim 10, comprising operand decoding means that is connected to said instruction storing means via an operand bus so as to decode an operand part of the instruction of said instruction set and assigns one operation code to a plurality of operands on the basis of information for assigning the operation code to said plurality of mnemonics.

15. An information processing apparatus according to claim 11, comprising operand decoding means that is connected to said instruction storing means via an operand bus so as to decode an operand part of the instruction of said instruction set and assigns one operation code to a plurality of operands on the basis of information for assigning the operation code to said plurality of mnemonics.

16. An information processing apparatus according to claim 12, comprising operand decoding means that is connected to said instruction storing means via an operand bus so as to decode an operand part of the instruction of said instruction set and assigns one operation code to a plurality of operands on the basis of information for assigning the operation code to said plurality of mnemonics.
